(19) United States
(12) Patent Application Publication
(10) Pub. No.: US 2009/0189513 A1
(43) Pub. Date: Jul. 30, 2009

(54) LED using thin film dichroic filters

(75) Inventor: James D. Lane, Dunedin, FL (US)

Correspondence Address: THE LAW OFFICES OF DENNIS L. COOK, PLLC, 10004 MARATHON COURT, TAMPA, FL, 33615, US

(73) Assignee: Ocean Optics, Inc., Dunedin, FL (US)

(21) Appl. No.: 12/321,838

(22) Filed: Jan. 26, 2009

Related U.S. Application Data
(60) Provisional application No. 61/062,607, filed on Jan. 28, 2008.

(51) Int. Cl. H01J 1/72

(52) U.S. Cl. 313/502

(57) ABSTRACT

An improved LED using patterned coated dichroic filters. More specifically a method for placing, during the wafer fabrication, patterned dichroic filters between the LED chip and phosphor layer to increase luminous efficiency and lower thermal load, and/or over the phosphor layer for spectral shaping and reduction of color temperature shift with viewing angle.

### CROSS-REFERENCE TO RELATED APPLICATION

The present application claims the benefit of previously filed co-pending Provisional Patent Application, Ser. No. 61/062,607.

### FIELD OF THE INVENTION

This invention relates, generally, to methods for making an improved LED using patterned coated dichroic filters. More specifically a method for placing, during the wafer fabrication, patterned dichroic filters between the LED chip and phosphor layer to increase luminous efficiency and lower thermal load, and/or over the phosphor layer for spectral shaping and reduction of color temperature shift with viewing angle.

### BACKGROUND OF THE INVENTION

Dichroic filters, also known as interference filters, are constructed by depositing one or more layers of metallic and/or dielectric films with precise thicknesses to produce filters which transmit certain wavelengths of light and reflect others. The colors of a dichroic filter can be predicted and manufactured to match spectral functions such as the CIE tristimulus curves s (e.g. the 1976 UCS standard chromaticity diagram), and such filters enable purer color filtering, reflection and transmission compared to gels due to their higher extinction ratio at wavelengths which are blocked and higher transmission at wavelengths that are passed. Dichroic filters are temperature stable from a range of about −80 degrees to 700 degrees F. They absorb less than two per cent (2%) of the light transmitted through them as they are primarily rejecting out of band wavelengths through reflection. And, for in band wavelengths, they exhibit greater than ninety per cent (90%) transmission thus requiring less power to achieve greater brightness. A process for making dichroic filters is disclosed in U.S. Pat. No. 5,711,889, Method For Making Dichroic Filter Array, which is hereby fully incorporated into this specification.

The object of the present invention disclosed in this patent application is the application and patterning of a photosensitive material as outlined in U.S. Pat. No. 5,711,889, during the wafer fabrication of LEDs, creating patterned dichroic filters between the LED chip and phosphor layer to increase luminous efficiency and lower thermal load, and/or over the phosphor layer for spectral shaping and reduction of color temperature shift with viewing angle.

U.S. Pat. No. 7,245,072 to Ouderkirk, et al. discloses a light source that includes a LED that emits excitation light, a polymeric multilayer reflector that reflects the excitation light and transmits visible light, and a layer of phosphor material spaced apart from the LED. The phosphor material emits visible light when illuminated with the excitation light. The polymeric multilayer reflector reflects excitation light onto the phosphor material. The layer of phosphor material is disposed between the LED and the polymeric multilayer reflector.

U.S. Pat. No. 6,791,259 to Stokes, et al. discloses a lamp containing a radiation source, a luminescent material and a radiation scattering material located between the radiation source and the luminescent material is provided. The lamp may be a white emitting lamp. The radiation source may be a blue emitting LED. The luminescent material may be a yellow emitting phosphor or dye. The radiation scattering material may be ceramic particles, such as TiO.sub.2 particles, in a carrier medium, such as glass, epoxy or silicone.

These, and all other prior art disclosures Applicant is aware of, do not describe an interference filter that is placed between the light source (a blue LED chip) and the phosphor overcoat (yellow emission when pumped by the blue LED). Also, none of the prior art describes a filter coating that is patterned so that the die surface has a clean area for bonding an electrical lead to it or for other purposes.

### SUMMARY OF THE INVENTION

This breakthrough in using patterned dichroic filters during LED production is made possible by uniting two separate and divergent technologies. The art of microlithography has long been employed to produce microelectronic devices, and the optical arts have long been employed to produce dichroic filter arrays. As mentioned earlier, the optical arts have failed to produce thin filters having well-defined edges, and the art of microlithography has been limited to the field of microelectronics. The present invention uses the divergent arts of microlithography and microelectronics to improve LEDs. A “cold process,” well known in the art of microelectronics, is employed to deposit the filter material, in lieu of the conventional “hot process.” Starting with a filter substrate, a releasing agent is applied to the wafer prior to the deposition there onto of a photoresist. Then the release layer is overetched to create an undercut, thereby weakening the walls formed by the photoresist and the unetched releasing agent. The dichroic filter material is then deposited onto the wafer in the space created by the etching. The photoresist and releasing agent are then removed, thereby leaving on the wafer the filter material. This process is repeated laying down a pattern of dichroic filter material, but is stopped short of completing the layers required for the spectral characteristics of the filter. The spectral characteristics are completed by adding a blanket coating of a material such as an anti-reflective material. These patterned dichroic filters are placed either between the LED chip and phosphor layer to increase luminous efficiency and lower thermal load, and/or over the phosphor layer for spectral shaping and reduction of color temperature shift with viewing angle.

It is therefore clear that a primary object of this invention is to advance the art of LED manufacture using patterned dichroic filters. A more specific object of the present invention is to advance said art by providing a LED with increased luminous efficiency and lower thermal load, and/or also spectral shaping and reduction of color temperature shift with viewing angle.

These and other important objects, features, and advantages of the invention will become apparent as this description proceeds. The invention accordingly comprises the features of construction, combination of elements and arrangement of parts that will be exemplified in the construction hereinafter set forth, and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1a is the first diagram of a method of making a patterned coated dichroic filter showing the substrate;

FIG. 1b is the second diagram of a method of making a patterned coated dichroic filter with a deposited dichroic material on the substrate;

FIG. 1c is the third diagram of a method of making a patterned coated dichroic filter with a blanket coating applied after depositing the dichroics resulting in the finished filter;

FIG. 2a is the first diagram of a method of making a patterned coated dichroic filter showing the substrate;

FIG. 2b is the second diagram of a method of making a patterned coated dichroic filter adding the blanked coating;

FIG. 2c is the third diagram of a method of making a patterned coated dichroic filter with the blanked coating and adding the dichroics resulting in the finished filter;

FIG. 3 is a diagram of a standard phosphor enhanced blue die white LED;

FIG. 4 is a spectrum of a white LED;

FIG. 5 is a diagram of an improved phosphor enhanced blue die white LED with a thin film blue pass dichroic reflective coating between the die and the phosphor coating;

FIG. 6 is a diagram of a standard phosphor enhanced blue die white LED with a color balancing thin film patterned dichroic filter over the phosphor layer; and

FIG. 7 is a spectrum of the color balancing thin film patterned dichroic filter over the phosphor layer showing reduction of color temperature shift versus viewing angle.

### DETAILED DESCRIPTION OF THE PREFERRED EMBODIMENT

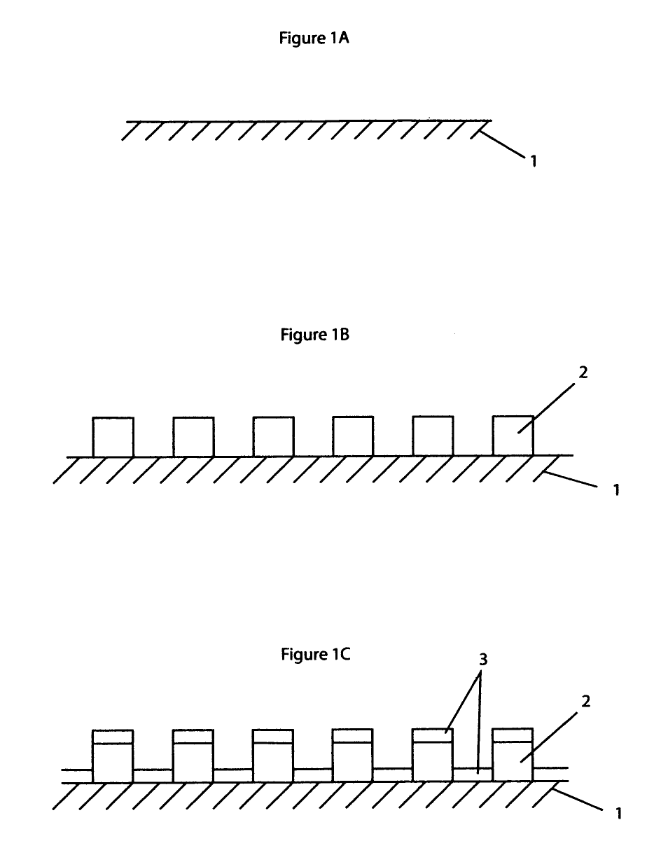

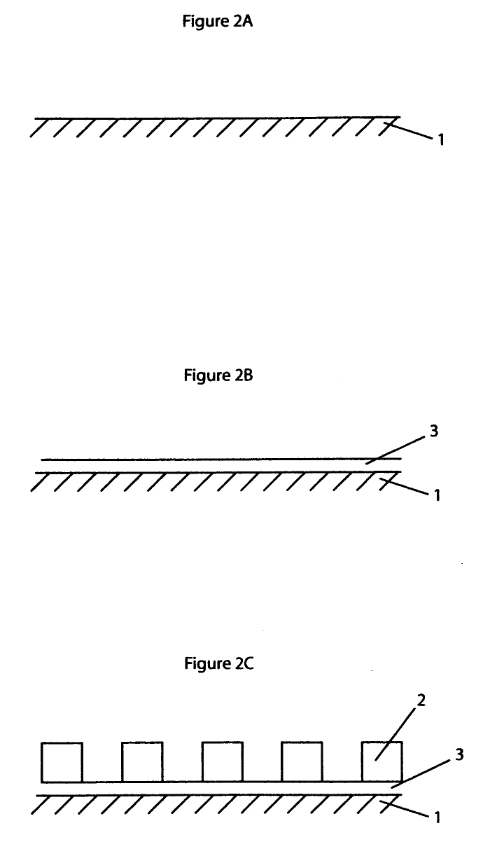

As shown in FIGS. 1a, 1b, and 1c the method and filter of this disclosure begins with the application and patterning of a photosensitive material (not shown) on a wafer substrate (1), more specifically, a LED wafer, as outlined in U.S. Pat. No. 5,711,889 but leaving off several dichroic layers of the patterned dichroic material (2) and replacing them with a blanket coating (3) such as an anti-reflective coating to complete the spectral characteristics desired. The steps as described in U.S. Pat. No. 5,711,899 are generally patterning photoresist on a wafer substrate (1) and masking pre-selected areas of said substrate via proximity, contact printing or other masking techniques well known in the art and coating a dichroic material (2) in the desired pattern. In most cases, but not all, multiple alternating layers of SiO2 and Ta2O5 are applied while lifting off the photoresist to form the patterned dichroic material (2). Then the whole surface is coated with an anti-reflective blanket coating (3) which, when combined with the patterned dichroic material (2), completes the spectral performance of that patterned dichroic material (2) section and, in the clear areas (4), provides an anti-reflective blanket coating (3). The final product produced by this method is shown in FIG. 1(c). Also, as shown in FIGS. 2a, 2b, and 2c, the steps can be reversed by applying the anti-reflective blanket coating (3) first on the substrate (2) and placing the patterned dichroic material (3) on top of the coating. The resulting filter is shown in FIG. 2(c). This patterning process is described more fully in pending application U.S. Ser. No. 10/959,800, “Patterned Coated Dichroic Filter” which is incorporated herein.

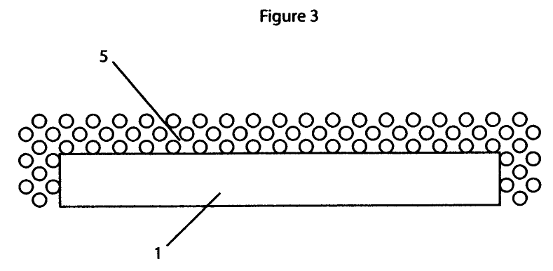

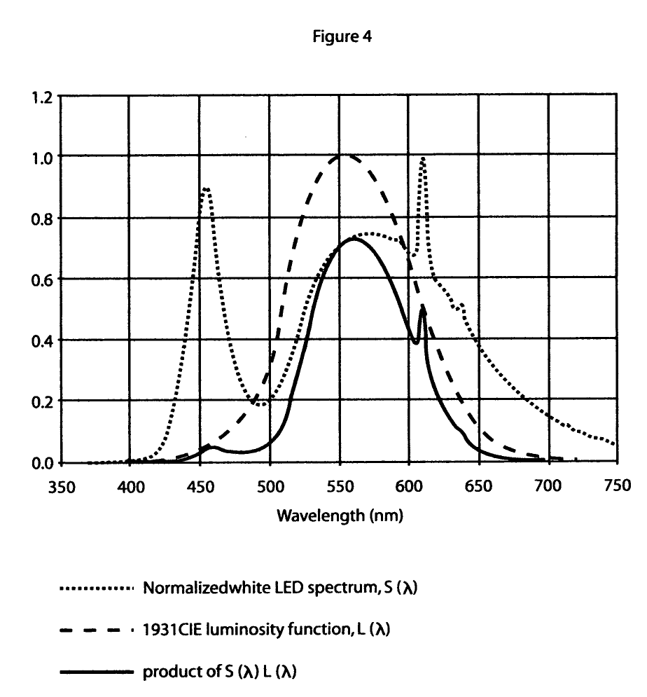

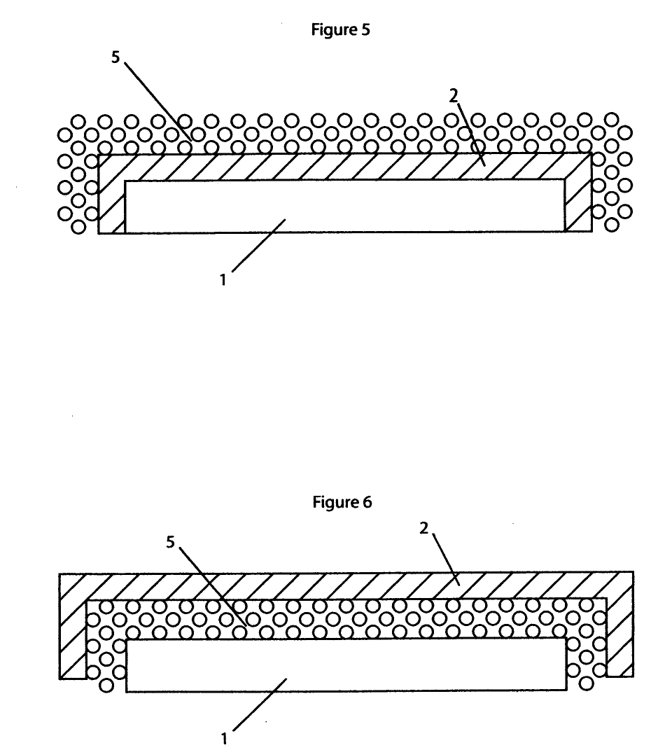

In one embodiment of the invention the standard phosphor enhanced blue die white LED shown in FIG. 3, and having a spectrum shown in FIG. 4, is enhanced during the wafer manufacture by adding the thin film blue pass dichroic reflective filter (2) between the LED die wafer (1) and the Phosphor granules as described above and as shown in FIG. 5. The blue pass reflector coating (2) allows the 440 nm blue excitation energy to pass from the LED die (1) to the phosphor overlay (5) while reflecting the phosphor reverse emission forward, thus increasing the luminous efficiency and reducing thermal loads on the LED die (2). This thin film filter (2) reflects wavelengths emitted from the phosphor in the direction of the LED die which would otherwise be lost back out of the device for increased luminous efficiency and less thermal load on the die.

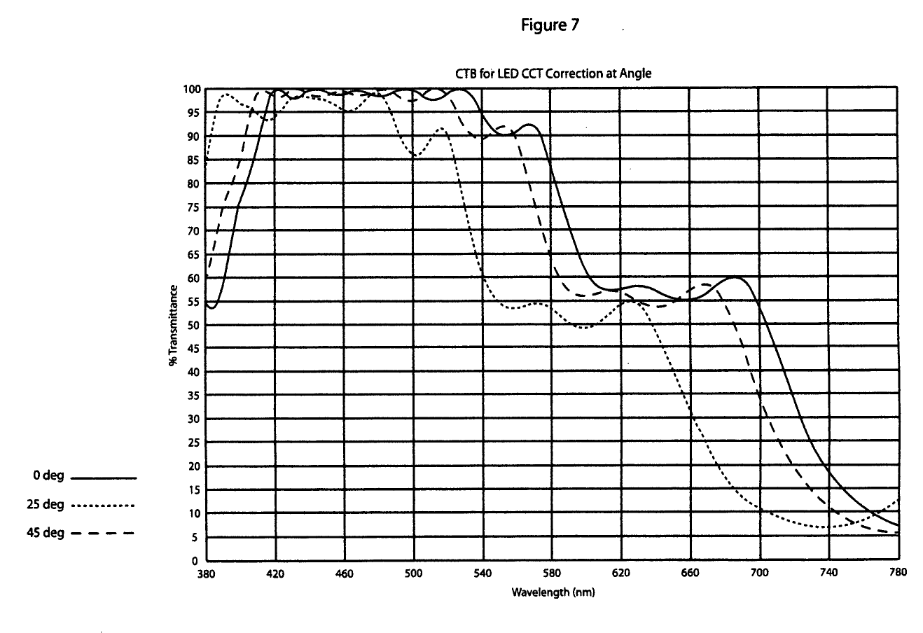

In another embodiment of the invention the standard phosphor enhanced blue die white LED shown in FIG. 3 is enhanced during the wafer manufacture by adding a thin film filter coating (2) over the conformal phosphor layer (5) as described above and as shown in FIG. 6 for spectral shaping of the emitted light for emissive color balancing. A thin film filter coating (2) could also be added over the conformal phosphor layer (5) that corrects for off-axis color temperature variation by utilizing the inherent spectral shift of a CTB interference filer at increasing angles of incidence as shown in FIG. 7.

A reflection reducing AR film is another of the optical filter types that can be applied to the LED die wafer surface. This would be in either the patterned configuration or as a blanket coating over a prior deposited patterned optical filter coating as described above. Since there is currently quite a lot of energy lost at the top surface of the LED die due to the large mismatch of the refractive indices of the top layer material and the medium (air, or optical epoxy of plastic lens material for example) the light passes into—An AR film will “match” the two indices and provide greater transmission (and thereby greater efficiency).

The benefits of wafer-level patterned thin film filters include: Optical properties can be precisely tuned to geometry; multiple lithography steps are possible on a single chip; “Swiss cheese” attenuation and apodization are possible; the thin film application can be localized to a desired area such as bond pads, etc. that can be left untouched: and, the wafer-level processing is cost effective.

It will thus be seen that the objects set forth above, and those made apparent from the foregoing description, are efficiently attained. Since certain changes may be made in the foregoing construction without departing from the scope of the invention, it is intended that all matters contained in the foregoing construction or shown in the accompanying drawings shall be interpreted as illustrative and not in a limiting sense.

What is claimed is:

1. An improved light emitting diode using dichroic filters, comprising:
a light emitting diode wafer;
a dichroic filter deposited over said light emitting diode wafer; and,
a phosphor layer deposited over said dichroic filter.

2. The improved light emitting diode of claim 1 wherein said dichroic filter is a patterned dichroic filter.

3. The improved light emitting diode of claim 2 wherein said patterned dichroic filter has a blanket coating.

4. The improved light emitting diode of claim 1 wherein a reflection reducing AR film is deposited in a patterned configuration or blanket coating over said phosphor layer to match refraction indices of said phosphor layer and the medium the light from the improved light emitting diode passes into.

5. The improved light emitting diode of claim 2 wherein a reflection reducing AR film is deposited in a patterned configuration or blanket coating over said phosphor layer to match refraction indices of said phosphor layer and the medium the light from the improved light emitting diode passes into.

6. The improved light emitting diode of claim 3 wherein a reflection reducing AR film is deposited in a patterned configuration or blanket coating over said phosphor layer to match refraction indices of said phosphor layer and the medium the light from the improved light emitting diode passes into.

7. An improved light emitting diode using dichroic filters, comprising:
a light emitting diode wafer;
a phosphor layer deposited over said light emitting diode wafer; and,
a dichroic filter deposited over said phosphor layer.

8. The improved light emitting diode of claim 7 wherein said dichroic filter is a patterned dichroic filter.

9. The improved light emitting diode of claim 8 wherein said patterned dichroic filter has a blanket coating.

10. The improved light emitting diode of claim 7 wherein a reflection reducing AR film is deposited in a patterned configuration or blanket coating over said dichroic filter to match refraction indices of said dichroic filter and the medium the light from the improved light emitting diode passes into.

11. The improved light emitting diode of claim 8 wherein a reflection reducing AR film is deposited in a patterned configuration or blanket coating over said patterned dichroic filter to match refraction indices of said patterned dichroic filter and the medium the light from the improved light emitting diode passes into.

12. The improved light emitting diode of claim 9 wherein a reflection reducing AR film is deposited in a patterned configuration or blanket coating over said coated patterned dichroic filter to match refraction indices of said coated patterned dichroic filter and the medium the light from the improved light emitting diode passes into.

13. An improved light emitting diode using dichroic filters, comprising:
a light emitting diode wafer;
a dichroic filter deposited over said light emitting diode wafer;
a phosphor layer deposited over said dichroic filter; and,
a second dichroic filter deposited over said phosphor layer.

14. The improved light emitting diode of claim 13 wherein said dichroic filter and/or second dichroic filter are a patterned dichroic filter.

15. The improved light emitting diode of claim 14 wherein said patterned dichroic filter and/or second patterned dichroic filter have a blanket coating.

16. The improved light emitting diode of claim 13 wherein a reflection reducing AR film is deposited in a patterned configuration or blanket coating over said second dichroic filter to match refraction indices of said second dichroic filter and the medium the light from the improved light emitting diode passes into.

17. The improved light emitting diode of claim 14 wherein a reflection reducing AR film is deposited in a patterned configuration or blanket coating over said second patterned dichroic filter to match refraction indices of said second patterned dichroic filter and the medium the light from the improved light emitting diode passes into.

18. The improved light emitting diode of claim 15 wherein a reflection reducing AR film is deposited in a patterned configuration or blanket coating over said second coated patterned dichroic filter to match refraction indices of said second coated patterned dichroic filter and the medium the light from the improved light emitting diode passes into.
